(19) United States
(12) Patent Application Publication
(10) Pub. No.: US 2007/0175454 A1
(43) Pub. Date: Aug. 2, 2007

(54) Engine control device

(75) Inventors: Mitsuyoshi Shimazaki, Numazu-shi (JP); Kazuyoshi Kishibata, Numazu-shi (JP); Hiroyasu Sato, Numazu-shi (JP); Tomohiro Kinoshita, Numazu-shi (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Numazu-shi (JP)

(21) Appl. No.: 11/698,697

(22) Filed: Jan. 26, 2007

(30) Foreign Application Priority Data
Jan. 30, 2006 (JP) 2006-21378

(51) Int. Cl. F02M 1/00; F02N 17/00

(52) U.S. Cl. 123/497; 123/179.16

(57) ABSTRACT

An engine control device including: a fuel pump driving portion that starts operating a fuel pump between when an operation permit switch is turned on and an operation permit command is given and when a starter switch is closed and a start command is given, and continuously operates the fuel pump after the start command is given; the first fuel injection control portion that causes an injector to perform first fuel injection at the start of an engine when both conditions are met that the start command is given and that the fuel pump is continuously operated for a set time or longer; and a rotating electric machine control portion that starts driving a rotating electric machine that operates as an engine starting motor when the first fuel injection is completed, and stops driving the rotating electric machine when the start of the engine is completed.

### TECHNICAL FIELD OF THE INVENTION

The present invention relates to an engine control device that controls a fuel injection device, and a rotating electric machine that operates as an engine starting motor or a rotating electric machine that operates as both an engine starting motor and a battery charging generator, using a microprocessor.

### BACKGROUND OF THE INVENTION

An engine fuel injection device is comprised of an injector, a fuel pump that supplies fuel to the injector, and a control portion that controls the injector and the fuel pump. The amount of fuel injected from the injector depends on the pressure of the fuel supplied from the fuel pump to the injector (fuel pressure) and a time for opening a valve of the injector (a valve opening time). Generally, fuel pressure supplied to the injector is controlled to be maintained constant by a pressure regulator, and thus the amount of fuel injected by the injector is controlled by the valve opening time.

As described above, the fuel injection amount depends on the fuel pressure supplied to the injector and the valve opening time. Thus, for satisfactory startability of an engine, the fuel needs to be supplied to the injector with sufficient fuel pressure in order to inject fuel in an amount required at the start. Thus, as disclosed in Japanese Patent Laid-Open No. 2005-23911, there is provided means for first driving a fuel pump for a predetermined time when a control device of an engine is powered on, and the pressure of fuel supplied to an injector is increased to a predetermined value before the start of cranking of the engine.

When a starting device starts the cranking of the engine, the control device controls fuel injection timing, a fuel injection time, and ignition timing based on information obtained from various sensors mounted to the engine. In the conventional control device, crank angle information of the engine is obtained from an output of a crank angle sensor mounted to the engine, and first fuel injection is performed when the fuel injection timing is detected based on the crank angle information. This causes a delay between the start of the cranking of the engine and the first fuel injection, which causes an air/fuel ratio of an air/fuel mixture supplied into a combustion chamber of the engine to reach a predetermined value with a delay, thereby failing in ignition of the fuel in first ignition (initial explosion), and reducing startability of the engine.

Poor startability of the engine increases the time for driving a rotating electric machine as a starter motor to increase power consumption of a battery, which requires a high capacity battery and is uneconomical.

When the rotating electric machine is driven as the motor, an extremely large amount of electric power is consumed to significantly reduce a terminal voltage of the battery. FIG. 15 shows an example of measurement results of changes in rotational speed and battery voltage at the start of the engine, with a driving time of the rotating electric machine as the starter motor on the axis of abscissa. In FIG. 15, the curve a indicates a rotational speed (a cranking speed) of the engine, and the curve b indicates a battery voltage. Switching of energization performed by a rectifier mechanism constituted by a commutator and a brush (for a brushless motor, switching of energization pattern) causes a driving current of the starter motor to finely vary, and thus a waveform of the battery voltage significantly changes as shown in FIG. 15 with the variations in the driving current. When the battery voltage decreases, a driving voltage of the injector decreases, and thus a valve of the injector is opened with a delay to prevent a desired amount of fuel from being injected from the injector as described later.

The injector does not open the valve immediately after the driving voltage is supplied, but there is a delay time (referred to as an ineffective injection time) between when the driving voltage is supplied and when the valve is actually opened. Thus, when the fuel injection amount is controlled, a valve opening time required for obtaining the injection amount required for maintaining an air/fuel ratio of an air/fuel mixture within a predetermined range is arithmetically operated relative to various control conditions as an effective injection time. Then, the effective injection time plus the ineffective injection time is regarded as an apparent fuel injection time, and an injection command signal having a signal width corresponding to the apparent fuel injection time is provided to an injector driving portion. The injector driving portion supplies the driving voltage to the injector while receiving the injection command signal, and causes the injector to inject fuel for the effective injection time.

As shown in FIG. 14, the ineffective injection time of the injector changes with the magnitude of the driving voltage supplied to the injector, and is significantly increased with decreasing injector driving voltage. Thus, as shown in FIG. 15, if the battery voltage decreases at the start of the engine to reduce the injector driving voltage, the ineffective injection time of the injector is increased to delay opening of the valve of the injector. The delay of the opening of the valve of the injector causes a shortage in fuel injection amount even if the fuel pressure supplied to the injector is sufficiently increased, thereby often failing in initial explosion of the engine, and inevitably reducing startability of the engine.

Thus, it is supposed that the battery voltage is detected, and the ineffective injection time added to the effective injection time is corrected according to the battery voltage, thereby preventing a reduction in the injection amount with decreasing injector driving voltage.

However, at the start of the engine, changes in internal pressure of a cylinder caused by a stroke change of the engine cause a load applied to the starter motor to vary, and as indicated by the curve a in FIG. 15, the rotational speed finely changes according to crank angles, and the variation in the load causes the battery voltage to change. Also, at the start of the engine, a waveform of the battery voltage significantly changes as indicated by the curve b in FIG. 15 with the fine variation of the driving current of the starter motor.

As described above, the battery voltage significantly changes at the start of the engine, and thus it is actually difficult to detect the battery voltage to precisely arithmetically operate the ineffective injection time, and difficult to properly correct the ineffective injection time relative to the battery voltage to control the fuel injection amount with high accuracy.

In order to prevent a shortage in fuel injection amount at the start of the engine, a microfilm of Japanese Utility Model Laid-Open No. 60-90540 proposes that an injector is driven to perform first fuel injection when an operation permit switch (for example, a key switch) that is turned on in permitting the operation of the engine is closed (when an operation permit command is given), and then a starter motor is activated.

If sufficient fuel pressure is supplied to the injector when the operation permit switch is closed, and the starter motor can be activated after the first fuel injection without a delay, the control described in Japanese Utility Model Laid-Open No. 60-90540 can prevent a shortage of fuel at the start of the engine to improve startability of the engine.

However, when the operation permit switch is closed, the fuel pressure supplied to the injector is often insufficient. If the fuel pressure supplied to the injector is insufficient when the operation permit switch is closed, as shown in Japanese Utility Model Laid-Open No. 60-90540, a desired amount of fuel cannot be injected even if fuel is injected when the operation permit switch is closed, and thus an air/fuel ratio of an air/fuel mixture in a cylinder in which first ignition is performed after the start goes lean, thereby failing in initial explosion, and inevitably reducing startability. The failure in the initial explosion causes unburned gas to be exhausted to pollute the atmosphere.

Further, if the time is long between when the operation permit switch is closed and when the starter switch is closed, the fuel injected by the injector adheres to an inner surface of an intake pipe or an inner surface of a cylinder to form a liquid film, which causes a shortage of fuel that contributes to combustion, and reduces startability of the engine. Also in this case, the failure in the ignition in the cylinder causes unburned gas to be exhausted to unpreferably pollute the atmosphere.

### SUMMARY OF THE INVENTION

The present invention has an object to provide an engine control device that prevents a shortage in fuel injection amount at the start of an engine to improve startability of the engine, and prevents exhaust of unburned gas to improve an exhaust gas characteristic at the start of the engine.

The present invention is applied to an engine control device that controls a fuel injection device including an injector that injects fuel to be supplied to an engine and a fuel pump that supplies the fuel to the injector, and a rotating electric machine that operates as a motor that rotatably drives a crankshaft of the engine at the start of the engine, using a microprocessor.

The engine control device according to the present invention includes: a fuel pump driving portion that starts operating the fuel pump between when an operation permit command to permit the operation of the engine is given and when a start command to start the engine is given, and continuously operates the fuel pump after the start command is given; first fuel injection control means for causing the injector to perform first fuel injection at the start of the engine when both conditions are met that the start command is given and that the fuel pump is continuously operated for a set time or longer, or when the start command is given within a set limited time after the continuous operation of the fuel pump for a time longer than the set time is stopped; rotating electric machine control means for controlling the rotating electric machine so as to start driving the rotating electric machine as the motor when the first fuel injection is completed, and stop driving the rotating electric machine as the motor when the start of the engine is completed; and normal state fuel injection control means for causing the injector to perform fuel injection at a predetermined crank angle position of the engine.

The operation permit command is typically given by an input operation of a key switch, but the present invention is not limited to the case where the operation permit command is given by the operation of the key switch. For example, when a keyless system is used that determines that an operation permit command is given when receiving identifying radio waves generated by an IC chip carried by a driver, the state where the system receives the identifying radio waves is the state where the operation permit command is given. Also, the set time is an operating time of the fuel pump required for increasing fuel pressure supplied to the injector to a required value. The set time is preferably set to the minimum necessary.

As one measure to improve startability of an engine, it is supposed that a fuel pump is driven for a certain time to increase fuel pressure supplied to an injector after an operation permit command is given and before a start command of the engine is given, and then first fuel injection is performed when the start command is given. However, with such a configuration, if the time is long between when driving of the fuel pump is stopped and when the start command is given, a leak from a check valve of the fuel pump causes a reduction in fuel pressure supplied to the injector, thereby preventing a sufficient amount of fuel from being injected in the first fuel injection.

On the other hand, in the present invention, the operation of the fuel pump is started between when the operation permit command to permit the operation of the engine is given and when the start command to start the engine is given, and the injector is caused to perform the first fuel injection at the start of the engine when both conditions are met that the start command is given and that the fuel pump is continuously operated for the set time or longer, thereby allowing a sufficient amount of fuel to be injected in the first fuel injection.

If the time is long between when the first fuel injection is performed and a starter motor is driven, the fuel injected in the first fuel injection adheres to a tube wall to form a liquid film, which may cause an air/fuel ratio of an air/fuel mixture supplied into a cylinder of the engine when the starter motor is driven to go lean, thereby reducing startability. On the other hand, in the present invention, the starter motor is driven to start the engine immediately after the first fuel injection, thereby preventing an air/fuel mixture from going lean, and improving startability of the engine.

Thus, according to the present invention, the startability of the engine can be improved, thereby preventing unburned gas from being exhausted at the start of the engine, and improving an exhaust gas characteristic at the start.

As described above, the first fuel injection control means is comprised so as to cause the injector to perform the first fuel injection at the start of the engine when both the conditions are met that the start command is given and that the fuel pump is continuously operated for the set time or longer, or when the start command is given within the set limited time after the continuous operation of the fuel pump for the time longer than the set time is stopped. Thus, even if the start command is given after the first operation of the fuel pump is stopped, the first fuel injection can be immediately performed when an operation stop time of the fuel pump is short. Thus, the time between when the start command is given and when the first fuel injection is performed can be reduced to improve startability.

The fuel pump driving portion may be comprised so as to operate the fuel pump for a certain time when the operation permit command to permit the operation of the engine is given, and continuously operate the fuel pump after the start command to start the engine is given.

The fuel pump driving portion may be also comprised so as to start the continuous operation of the fuel pump when the start command to start the engine is given after the operation permit command to permit the operation of the engine is given. In this case, the first fuel injection control means is comprised so as to cause the injector to perform the first fuel injection at the start of the engine when the start command is given and the operating time of the fuel pump reaches the set time.

With the above described configuration, there is no need for performing first driving of the fuel pump when the operation permit command is given, thereby preventing the first driving of the fuel pump from being unnecessarily performed and preventing unnecessary consumption of electric power in the case where the time is long between when the operation permit command is given and when the start command is given.

In a preferable aspect of the present invention, the rotating electric machine is provided so as to operate as a motor that starts the engine at the start of the engine, and be driven by the engine after the start of the engine and operate as a battery charging generator. In this case, the rotating electric machine control means is comprised so as to start driving the rotating electric machine as the motor when the first fuel injection is completed, stop the driving of the rotating electric machine as the motor when the start of the engine is completed, and control a generation output of the rotating electric machine that operates as the generator for maintaining a voltage across a battery within a set value range after the start of the engine is confirmed. Also when such a rotating electric machine is used, the fuel pump driving portion and the first fuel injection control means may have various constructions.

The operation of the engine naturally requires normal state fuel injection control means for injecting fuel at a predetermined crank angle position (a position suitable as a fuel injection start position for maintaining an air/fuel ratio of an air/fuel mixture supplied into a cylinder within a proper range) after cranking of the engine is started. Specifically, the control device according to the present invention requires at least the fuel pump driving portion, the first fuel injection control means, and the normal state fuel injection control means in connection with the control of the fuel injection amount. When the rotating electric machine is used that operates as the engine starting motor at the start of the engine, and is driven by the engine after the start of the engine and operates as the battery charging generator, starter generator control means is required for performing both control to operate the rotating electric machine as the motor and output control to operate the rotating electric machine as the generator. The control device including an electronic control ignition device further requires means for controlling ignition timing. If these controls are performed by using one microprocessor, the number of control items is increased to make difficult the control of each item with high accuracy.

Thus, in a preferred aspect of the present invention, two microprocessors are provided, and the fuel pump driving portion, the first fuel injection control means, and the normal state fuel injection control means are comprised of one of the two microprocessors, and the starter generator control means is comprised of the other of the two microprocessors.

The control of the ignition timing may be performed by any of the microprocessors, but if there is an apparent difference in burden between the two microprocessors, the control is preferably performed by a microprocessor with a lower burden.

The controls are thus shared by the two microprocessors to reduce the number of the control items for each microprocessor, thereby allowing control of the fuel injection amount and control of the generation output to be performed with high accuracy.

### BRIEF DESCRIPTION OF THE DRAWINGS

The above and other objects and features of the present invention will be apparent from the detailed description of the preferred embodiments of the invention, which is described and illustrated with reference to the accompanying drawings, in which;

FIG. 1 is a block diagram showing a construction of hardware according to the first embodiment of the present invention;

FIG. 2 is a block diagram showing a construction of a control device including control means comprised of a microprocessor according to the first embodiment of the present invention;

FIG. 3 is a flowchart showing an example of an algorithm of a fuel pump driving processing executed by the microprocessor for constructing the control device in FIG. 2;

FIG. 4 is a flowchart showing an example of an algorithm of a starting control processing executed by the microprocessor for constructing the control device in FIG. 2;

FIGS. 5A to 5E are timing charts showing an exemplary operation of a fuel injection device and a starter motor at the start of an engine when the control device according to the first embodiment of the present invention is used;

FIGS. 6A to 6E are timing charts showing another exemplary operation of the fuel injection device and the starter motor at the start of the engine when the control device according to the first embodiment of the present invention is used;

FIGS. 7A to 7E are timing charts showing a further exemplary operation of the fuel injection device and the starter motor at the start of the engine when the control device according to the first embodiment of the present invention is used;

FIGS. 8A to 8E are timing charts showing an exemplary operation the fuel injection device and the starter motor at the start of the engine when a variant of a fuel pump driving portion is used in the control device according to the first embodiment of the present invention;

FIG. 9 is a block diagram showing a construction of the second embodiment of the present invention;

FIGS. 10A to 10E are timing charts showing an exemplary operation at the start of an engine when a control device according to the embodiment in FIG. 9 is used;

FIG. 11 is a block diagram showing a construction of hardware of a control device according to the third embodiment of the present invention;

FIG. 12 is a schematic circuit diagram showing an exemplary configuration of a starter generator drive circuit in FIG. 11;

FIG. 13 is a block diagram showing a construction of the control device including control means comprised of a microprocessor according to the third embodiment of the present invention;

FIG. 14 is a graph showing the relationship between an ineffective injection time and a driving voltage of an injector; and

FIG. 15 is a graph showing measurement results of the relationship between a battery voltage for driving a starter motor that starts an engine and an operating time of the starter motor, and the relationship between a rotational speed of the engine and the operating time of the starter motor.

### DETAILED DESCRIPTION OF THE PREFERRED EMBODIMENTS

Now, preferred embodiments of the present invention will be described in detail with reference to the drawings.

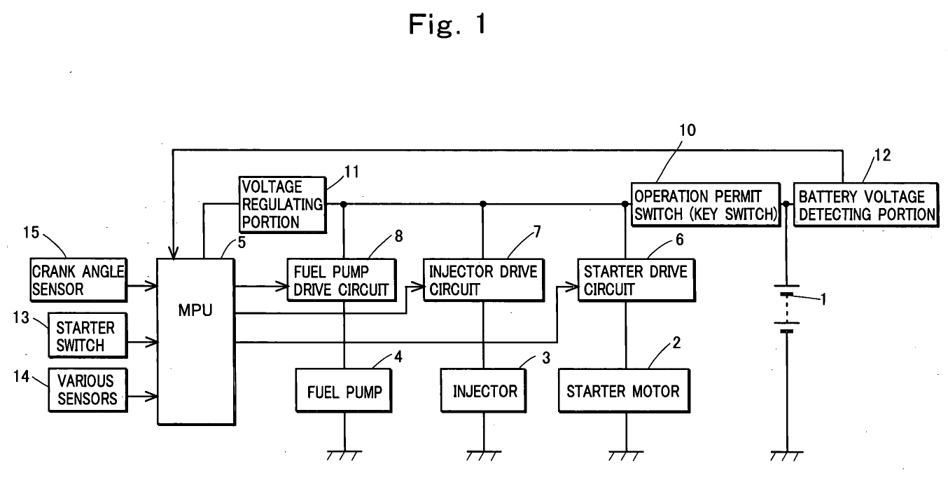

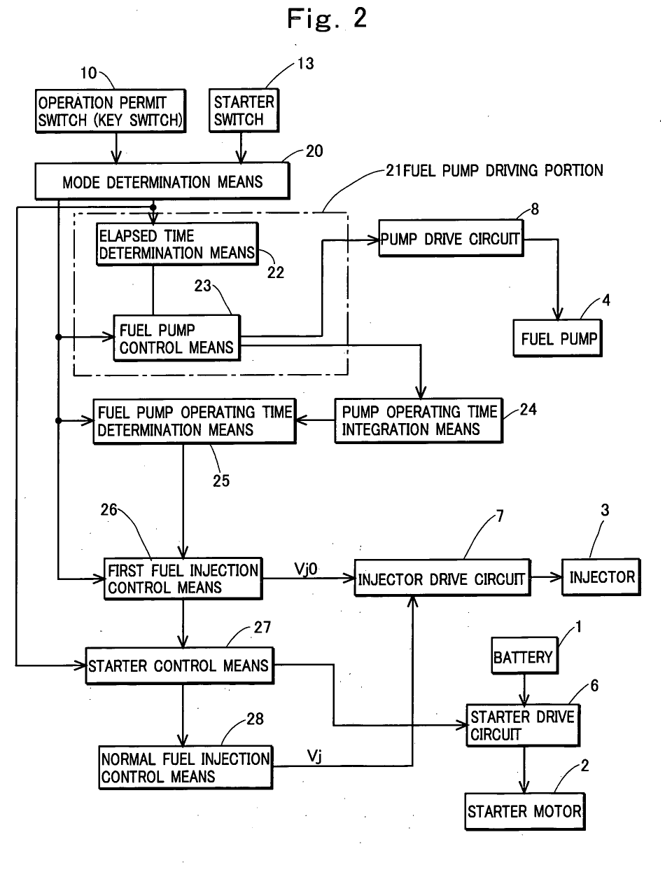

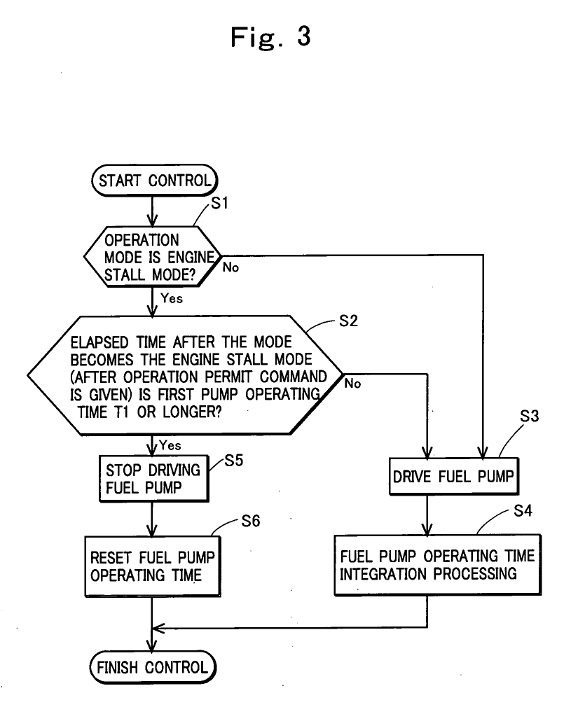

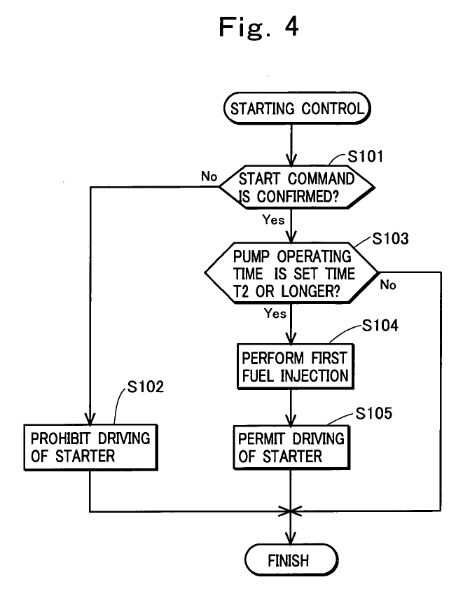

FIGS. 1 to 8 show the first embodiment of the present invention. FIG. 1 shows a construction of hardware, and FIG. 2 shows a construction of a control device including means comprised of a microprocessor. FIGS. 3 and 4 are flowcharts showing algorithms of programs executed by the microprocessor for constructing the means in FIG. 2, and FIGS. 5 to 8 are timing charts showing operations at the start of an engine in the embodiment.

The present invention may be applied to a control device that controls an engine having any number of cylinders, but for simplicity of explanation, an engine to be controlled is a single cylinder engine in the following description.

In FIG. 1, a reference numeral 1 denotes a battery, and 2 denotes a rotating electric machine that operates as an engine starting motor when an unshown engine is started. In this case, the rotating electric machine 2 is constituted by a starter motor.

A reference numeral 3 denotes an injector (an electromagnetic fuel injection valve) that injects fuel to be supplied to an unshown engine, 4 denotes a fuel pump that pumps up fuel in an unshown fuel tank and supplies the fuel to the injector 3, and 5 denotes a microprocessor (MPU) that receives a power voltage from the battery 1 and is operated.

A starter drive circuit 6 is provided for supplying a driving current to the starter motor 2, and an injector drive circuit 7 and a fuel pump drive circuit 8 are provided for supplying driving currents to the injector 3 and the fuel pump 4, respectively.

A voltage across the battery 1 is supplied to the starter drive circuit 6, the injector drive circuit 7, and the fuel pump drive circuit 8 through an operation permit switch (a key switch in this example) 10, and supplied to a power terminal of the microprocessor 5 through a voltage regulating portion 11. The starter drive circuit 6, the injector drive circuit 7, and the fuel pump drive circuit 8 include switches having the functions of turning on/off the driving currents of the starter motor 2, the injector 3, and the fuel pump 4, respectively, and when the switches are turned on, the driving currents are supplied to the starter motor 2, the injector 3, and the fuel pump 4 from the battery 1 as a power supply. The voltage regulating portion 11 converts the voltage across the battery 1 to a value suitable for driving the microprocessor 5 (for example, 5V), and supplies the voltage to the power terminal of the microprocessor 5.

A reference numeral 12 denotes a battery voltage detecting portion that detects the battery voltage, and information on the battery voltage obtained by the detecting portion is provided to the microprocessor 5. A reference numeral 13 denotes a starter switch that is turned on at the start of the engine to issue a start command, 14 denotes various sensors (an intake air temperature sensor, a cooling water temperature sensor, an atmospheric pressure sensor, an intake air pressure sensor, or the like) that detect control conditions for controlling a fuel injection amount, 15 denotes a crank angle sensor that detects crank angle information of the engine, and the start command issued by the starter switch 13 and the information detected by the various sensors 14 and the crank angle sensor 15 are provided to the microprocessor 5.

The microprocessor 5 executes programs stored in a ROM to construct various means that constitute the control device for controlling the engine. FIG. 2 shows a construction of essential portions of the control device including means relating to the present invention among the various means comprised of the microprocessor 5.

In FIG. 2, a reference numeral 20 denotes mode determination means for determining a control mode from the state of the operation permit switch 10 and the state of the starter switch 13. The mode determination means determines that the control mode is an engine stall mode when the operation permit switch 10 is turned on (the operation permit command is given) and the starter switch 13 is turned off (the start command is not given), and determines that the control mode is a start mode when the operation permit switch 10 is turned on (the operation permit command is given) and the starter switch 13 is turned on (the start command is given).

A reference numeral 21 denotes a fuel pump driving portion, which is comprised of elapsed time determination means 22, and fuel pump control means 23. The fuel pump driving portion 21 operates the fuel pump 4 at least for a certain time when the operation permit switch 10 is turned on (the operation permit command is given), and continuously operates the fuel pump 4 after the start command is given.

The elapsed time determination means 22 determines whether an elapsed time from the time when the mode determination means 20 determines that the control mode is the engine stall mode reaches a certain time (the first pump operating time) T1 previously set. The first pump operating time T1 is set to, for example, about 4 sec.

The fuel pump control means 23 provides a pump drive signal to the pump drive circuit 8 until the elapsed time determination means 22 determines that the elapsed time from the time when the mode determination means 20 determines that the control mode is the engine stall mode reaches the first pump operating time, and stops providing the drive signal to the pump drive circuit 8 when the elapsed time determination means 22 determines that the elapsed time reaches the first pump operating time.

The fuel pump control means 23 also provides a drive signal to the pump drive circuit 8 when the mode determination means 20 determines that the control mode is the start mode, and continues providing the drive signal to the pump drive circuit 8 until the operation permit switch 10 is opened (the operation permit command is cancelled).

Thus, the fuel pump driving portion 21 provides the drive signal to the pump drive circuit 8 and operates the fuel pump 4 during the previously set first pump operating time T1 when the operation permit switch 10 is turned on and the operation permit command is given, and stops providing the drive signal to the pump drive circuit 8 and stops operating the fuel pump 4 if the starter switch 13 is not turned on when the first pump operating time has passed.

The fuel pump driving portion 21 also provides a drive signal to the pump drive circuit 8 and starts operating the fuel pump 4 when the starter switch 13 is turned on and the control mode becomes the start mode, and thereafter continues operating the fuel pump until the operation permit switch 10 is turned off.

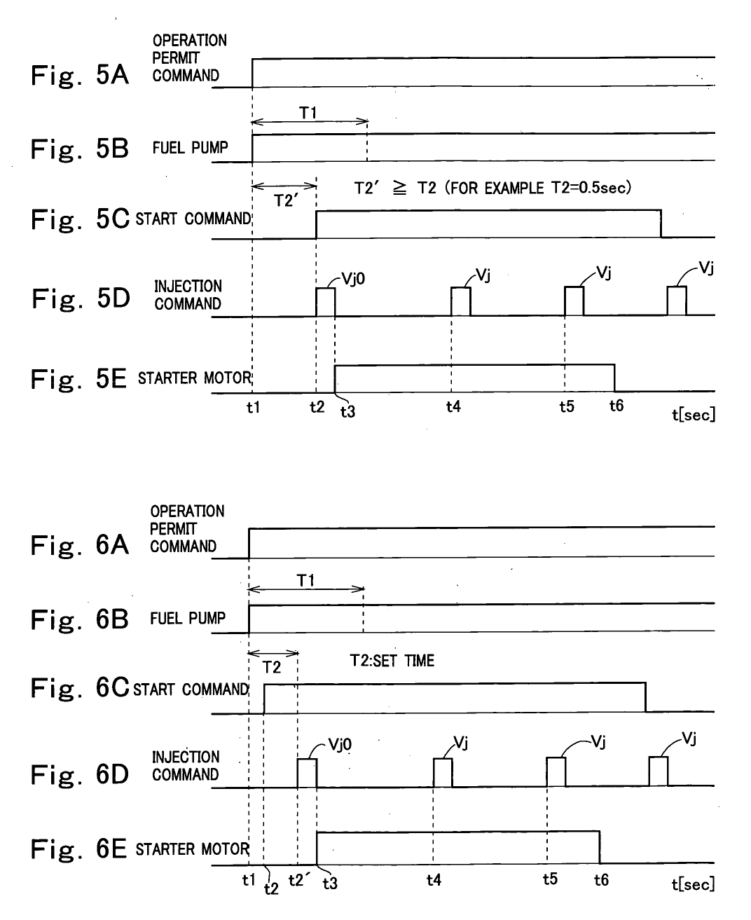

Thus, as shown in FIG. 5 or 6, when the starter switch is turned on (the start command is given) after the operation permit switch 10 is turned on and the operation permit command is given and before the first pump operating time T1 passes, the fuel pump 4 is not stopped even if the first pump operating time has passed, and the operation of the fuel pump 4 is continued between when the operation permit switch 10 is turned off and the operation permit command is canceled.

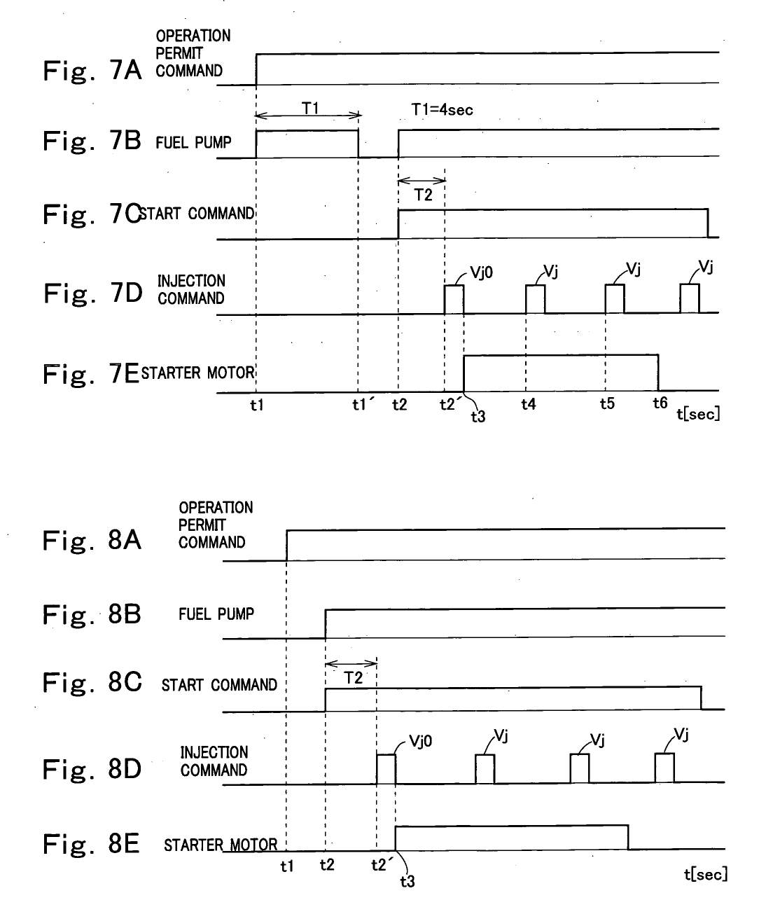

As shown in FIGS. 7A to 7E, when the starter switch is turned on (the start command is given) after the operation permit switch 10 is turned on and the operation permit command is given and then the first pump operating time T1 has passed, the operation of the fuel pump is once stopped when the first operating time T1 has passed, and restarted when the start command is given.

A reference numeral 24 denotes fuel pump operating time integration means for integrating a continuous operating time of the fuel pump 4, and 25 denotes fuel pump operating time determination means for determining whether the continuous operating time of the fuel pump integrated by the fuel pump operating time integration means 24 reaches a set time T2. The fuel pump control means 23 gives an integration command to the fuel pump operating time integration means 24 when instructing the operation of the fuel pump, and gives a reset command to the fuel pump operating time integration means 24 when stopping the operation of the fuel pump. Thus, the fuel pump operating time integration means 24 starts the integration of the operating time when the operation of the fuel pump is started, and resets the integrated value when the fuel pump control means 23 stops the fuel pump.

A reference numeral 26 denotes first fuel injection control means for providing the first injection command signal Vjo to the injector drive circuit 6 and causing the injector 3 to perform first fuel injection at the start of the engine when both conditions are met that the starter switch 13 is closed and the start command is given and that the fuel pump 4 is continuously operated for a set value (for example, 0.5 sec) T2 or longer, 27 denotes starter control means for controlling the starter motor 2 so as to start operating the starter motor 2 when the first fuel injection is completed, and stop operating the starter motor 2 when the start of the engine is completed, and 28 denotes normal state fuel injection control means for providing a normal state injection command signal Vj to the injector drive circuit 6 at a predetermined crank angle position of the engine, and causing the injector 3 to perform normal state fuel injection.

Maintaining the operation of the engine naturally requires means for controlling an ignition device that ignites the engine, and in some cases, requires control of exhaust timing of the engine or the like, but descriptions on means for such controls will be omitted.

FIGS. 3 and 4 show examples of algorithms of processing executed by the microprocessor for constructing essential portions of the control device in FIG. 2. The processing in FIG. 3 is a fuel pump drive interruption processing that is started when the operation permit switch 10 in FIG. 1 is turned on and the operation permit command is given, and repeatedly executed at very short time intervals.

In the interruption processing, it is determined in Step S1 whether an operation mode is the engine stall mode. A processing for achieving the mode determination means for determining the control mode is separately executed, and in the processing, when the operation permit switch is on (the operation permit command is given), the engine is stopped, and the starter switch is off (the start command is not given), it is determined that the control mode is the engine stall mode. When both the operation permit switch and the starter switch are on (the operation permit command is given and the start command is given), it is determined that the control mode is the start mode, and when the operation permit switch is on (the operation permit command is given), the starter switch is off (the start command is not given), and the engine is rotated at a predetermined rotational speed or higher, it is determined that the control mode is the normal operation mode.

When it is determined in Step S1 in FIG. 3 that the control mode is the engine stall mode, the process proceeds to Step S2, and it is determined whether the elapsed time after the control mode becomes the engine stall mode is the first pump operating time T1 or longer. When it is determined that the elapsed time after the control mode becomes the engine stall mode is shorter than the first pump operating time T1, the process proceeds to Step S3 and the fuel pump 4 is driven, and a processing for integrating the operating time of the fuel pump is executed in Step S4, and then the interruption processing is finished. When it is determined in Step S2 that the elapsed time after the control mode becomes the engine stall mode is the first pump operating time T1 or longer, the process proceeds to Step S5 and the operation of the fuel pump is stopped, and the integrated value of the operating time of the fuel pump is reset in Step S6, and then the interruption processing is finished.

When it is determined in Step S1 in FIG. 3 that the control mode is not the engine stall mode, the process proceeds to Step S3 and the fuel pump 4 is driven, and the processing for integrating the operating time of the fuel pump is executed in Step S4, and then the interruption processing is finished.

The processing in FIG. 4 is a starting control processing that is repeatedly executed at very short time intervals after the microprocessor 5 is powered on and until the start of the engine is completed. When this processing is started, first in Step S101, the state of the starter switch 13 is determined to confirm whether the start command is issued. When it is determined that the start command is not issued, the process moves to Step S102, a demand for prohibiting driving of the starter motor is issued, and then the starting control processing is finished.

When it is confirmed in Step S101 in FIG. 4 that the start command is issued, it is determined in Step S103 whether the continuous operating time of the fuel pump is the set time T2 or longer. When it is determined that the continuous operating time of the fuel pump has not reached the set time, no processing is performed thereafter and this processing is finished. When it is determined in Step S103 that the continuous operating time of the fuel pump reaches the set time T2, the process proceeds to Step S104 and the first fuel injection is executed, then driving of the starter motor is permitted in Step S105, a demand for driving the starter motor is issued to a starter motor control routine (not shown) for constructing the starter control means 27 in FIG. 2, and the starting control processing is finished. In the starter motor control routine, the driving of the starter motor is permitted, the drive signal is provided to the starter drive circuit 6 when the first fuel injection is completed to start energization of the starter motor 2, and the provision of the drive signal to the starter drive circuit 6 is stopped to stop the starter motor when the rotational speed of the engine becomes a start determination speed or higher and the completion of the start of the engine is detected. The starter control means 27 in FIG. 2 is comprised of the series of processes of the starter motor control routine.

The fuel pump operating time determination means 25 is comprised of Step S2 in FIG. 3 and Step S103 in FIG. 4, and the first injection command issuing means 26 is comprised of Steps S101, S103 and S104 in FIG. 4.

In the first fuel injection execution processing in Step S104 in FIG. 4, an effective injection time (a valve opening time) in the first fuel injection is arithmetically operated relative to a cooling water temperature or an intake air temperature of the engine, atmospheric pressure or the like, and an injection command signal having a signal width corresponding to an apparent injection time obtained by adding an ineffective injection time to the effective injection time is provided to the injector drive circuit 7. The injector drive circuit 7 supplies a driving voltage to the injector 3 while receiving the injection command signal, and causes the injector to perform the first fuel injection.

After the starter motor rotates a crankshaft of the engine, fuel injection control is performed by the normal state fuel injection control means 28. In normal state fuel injection control, a basic fuel injection time is arithmetically operated relative to an intake air amount of the engine detected by an air flow meter, estimated from the rotational speed of the engine and an intake pipe pressure, or estimated from a throttle valve opening degree and the rotational speed of the engine. Also, during the basic fuel injection time, the effective injection time is arithmetically operated by multiplying the basic fuel injection time by correction coefficient arithmetically operated relative to the control conditions such as the intake air temperature or the cooling water temperature of the engine, the atmospheric pressure, or the rotational speed of the engine, and the ineffective injection time is added to the effective injection time to arithmetically operate an apparent fuel injection time. Then, when fuel injection timing is detected from an output of the crank angle sensor or the like, an injection command signal having a signal width corresponding to the apparent fuel injection time is generated, and the injection command signal is provided to the injector drive circuit 7. The injector drive circuit 7 supplies the driving voltage to the injector 3 while receiving the injection command signal, and causes the injector 3 to inject fuel during the arithmetically operated effective injection time.

The microprocessor also arithmetically operates ignition timing of the engine relative to the rotational speed of the engine detected from the crank angle information obtained by the crank angle sensor 15, and causes an unshown ignition device that ignites the engine when detecting the arithmetically operated ignition timing to perform an ignition operation. This causes initial explosion in the cylinder of the engine and starts the engine.

In the starter motor control routine, the provision of the drive signal to the starter drive circuit 6 is stopped to stop the starter motor when the completion of the start of the engine is confirmed from the rotational speed of the engine.

FIGS. 5 to 7 are timing charts showing various exemplary operations at the start of the control device according to the embodiment. In the example in FIGS. 5A to 5E, as shown in FIG. 5A, the operation permit switch is turned on and the operation permit command is given at time t1, and then as shown in FIG. 5C, the starter switch 13 is turned on and the start command is given at time t2. When the operation permit command is given, the driving of the fuel pump 4 is started as shown in FIG. 5B. In this example, the starter switch is turned on and the start command is given after the operation permit command is given and the operation of the fuel pump is started and before the first pump operating time T1 (for example, 4 sec) passes, and thus the fuel pump is continuously operated without being stopped. In the example in FIGS. 5A to 5E, an elapsed time T2′ from the time t1 when the operation permit command is given to the time t2 when the start command is given is longer than the set time T2 (for example, 0.5 sec), and thus at the same time as the start command is issued, both conditions are met that the start command is given and that the fuel pump is continuously operated for the set time or longer. Thus, at the same time as the start command is given, the first injection command signal Vjo is generated, and this injection command signal is provided to the injector drive circuit 7. The first fuel injection is thereby performed. When the first fuel injection is performed, the starter motor has not been activated, thus the battery voltage is not reduced, and the ineffective injection time of the injector is not increased. This prevents a shortage in the fuel injection amount by the first fuel injection, and sufficient fuel is supplied to the engine for first ignition.

When the first fuel injection is completed at time t3, the driving current is immediately supplied to the starter motor 2, and the starter motor is activated as shown in FIG. 5E. Cranking of the engine is thereby performed. In the process of the cranking, when a predetermined fuel injection start position is detected at time t4, second fuel injection is performed by the injector, and thereafter fuel injection is performed at a predetermined crank angle position for each rotation of the crankshaft. When the start of the engine is confirmed at time t6 after several rotations of the crankshaft, the driving of the starter motor is stopped. After the rotation of the starter motor, the injection command signal Vj is generated at the predetermined fuel injection timing t4, t5, . . . , and normal state fuel injection is performed.

FIGS. 6A to 6E show the second exemplary operation at the start, and in this example, the operation permit command is given at time t1, and then the start command is given at time t2 before the set time T2 passes. In this case, the condition is not met that the continuous operating time of the fuel pump reaches the set time T2 when the start command is given, and thus the first fuel injection is not performed at the time t2. After the start command is given at the time t2, the first injection command signal Vjo is generated at time t2′ when the continuous operating time of the fuel pump reaches the set time T2, and the first fuel injection is performed at the time t2′. Then, when the first fuel injection is completed at time t3, energization of the starter motor is started, and when the completion of the start of the engine is detected at time t6, the energization of the starter motor is stopped.

FIGS. 7A to 7E show the third exemplary operation at the start, and in this example, the operation permit command is given at time t1, the first pump operating time T1 passes at time t1′, and the start command is given at time t2 after further passage of time. When the start command is given at the time t2, the continuous operation of the fuel pump is started. In this case, the fuel pump is not operated between the time t1′ when the first pump operating time passes and the time t2 when the start command is given, and the condition is not met that the continuous operating time of the fuel pump reaches the set time T1 when the start command is issued, and thus the first injection command signal Vjo is not generated at the time t2. The first injection command signal Vjo is generated at time t2′ when the set time T2 passes from the time t2, and the first fuel injection is performed, and when the fuel injection is completed at time t3, the driving of the starter motor is started. Other operations are the same as in FIGS. 5 and 6.

In the above described embodiment, the fuel pump is operated for the first operating time T1 when the operation permit command is given, but the continuous operation of the fuel pump may be started when the start command is issued as shown in FIGS. 8A to 8E rather than that the fuel pump is operated when the operation permit command is given. In this case, both the conditions that the start command is given and that the continuous operating time of the fuel pump reaches the set time T2 are met at the time t2′ when the set time T2 passes after the start command is issued at the time t2. Thus, the first fuel injection is performed at the time t2′, and the driving of the starter motor is started when the first fuel injection is completed at the time t3.

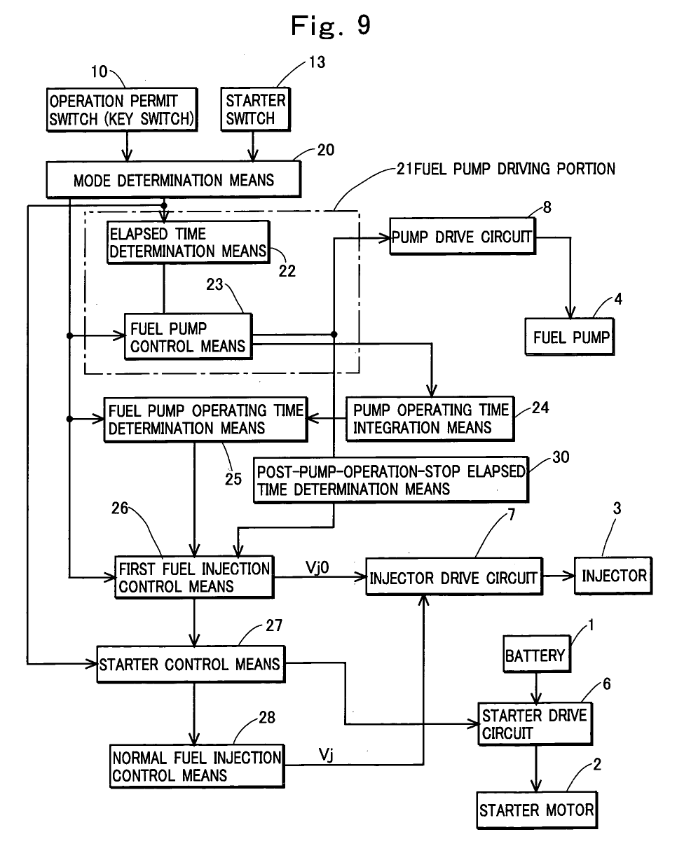

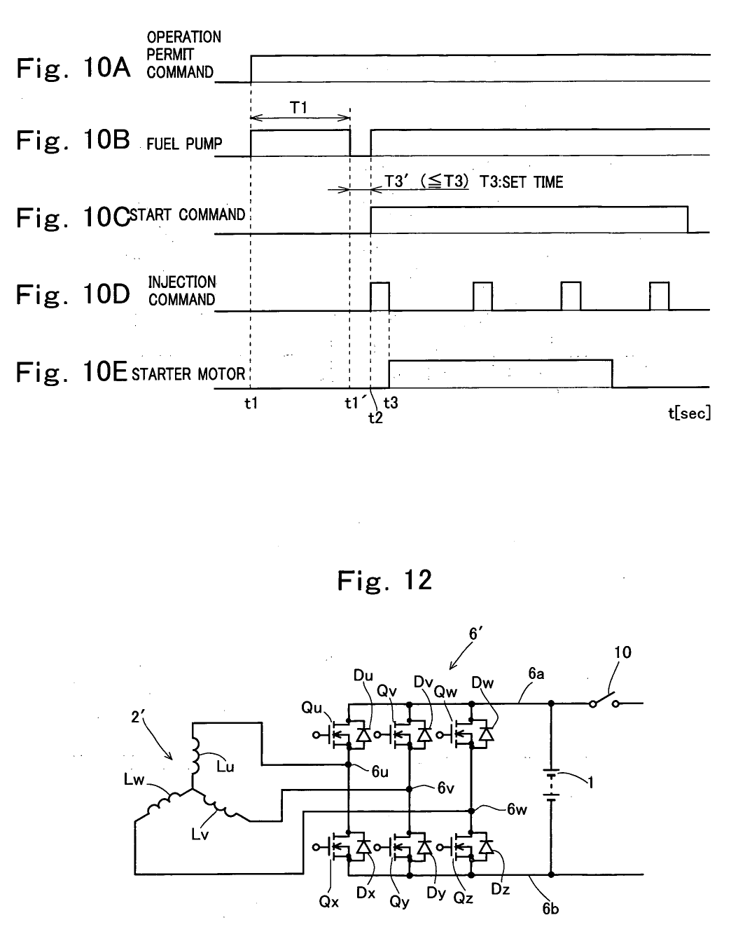

In the above described example, the operation of the fuel pump is started when the start command is issued and the fuel pump is not operated, and the first fuel injection is performed when the continuous operating time reaches the set time T2. As shown in FIGS. 10A to 10E, however, when the operation permit command is given at time t1 and the fuel pump is operated during the first pump operating time T1, and then the start command is given at time t2 when time T3′ passes, the first fuel injection may be immediately performed if the elapsed time T3′ is a set limited time T3 or shorter (if an operation stop time of the fuel pump is sufficiently short, and fuel pressure supplied to the injector is not reduced). Specifically, the first fuel injection control means may be comprised so as to cause the injector to perform the first fuel injection when both the conditions are met that the start command is given and that the fuel pump is continuously operated for the set time or longer, and also to cause the injector to perform the first fuel injection at the start of the engine when the start command is given within the set limited time T3 after the continuous operation of the fuel pump for a time longer than the set time is stopped. FIG. 9 shows a construction of a control device when the first fuel injection control means is thus comprised.

In this case, post-pump-operation-stop elapsed time determination means 30 is provided for measuring an elapsed time after first operation of a fuel pump is stopped, and determining whether the measured elapsed time is the limited time T3 or shorter, and the determination results of the determination means are provided to first fuel injection control means 26. Other constructions of the control device in FIG. 9 are the same as in the example in FIG. 2.

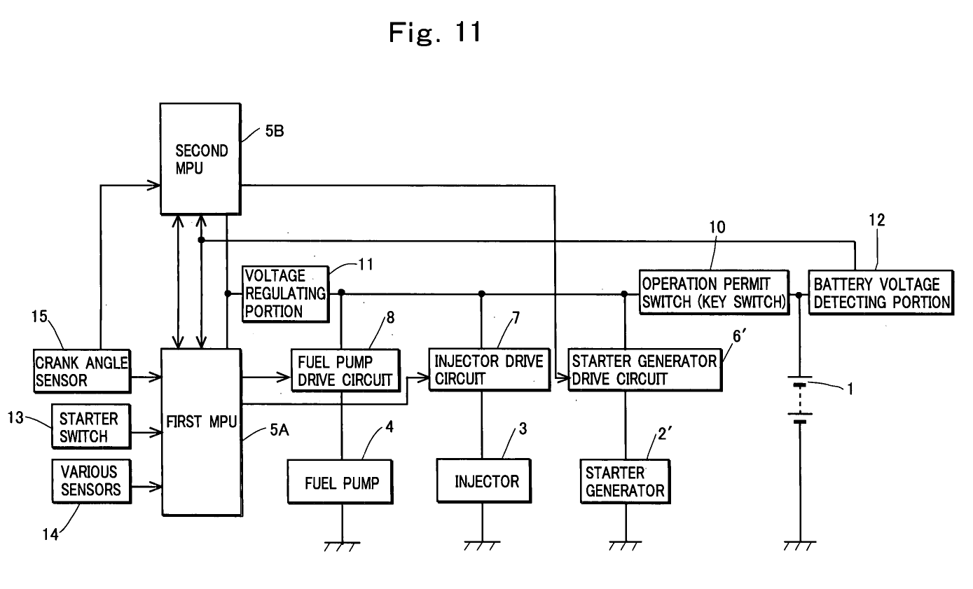

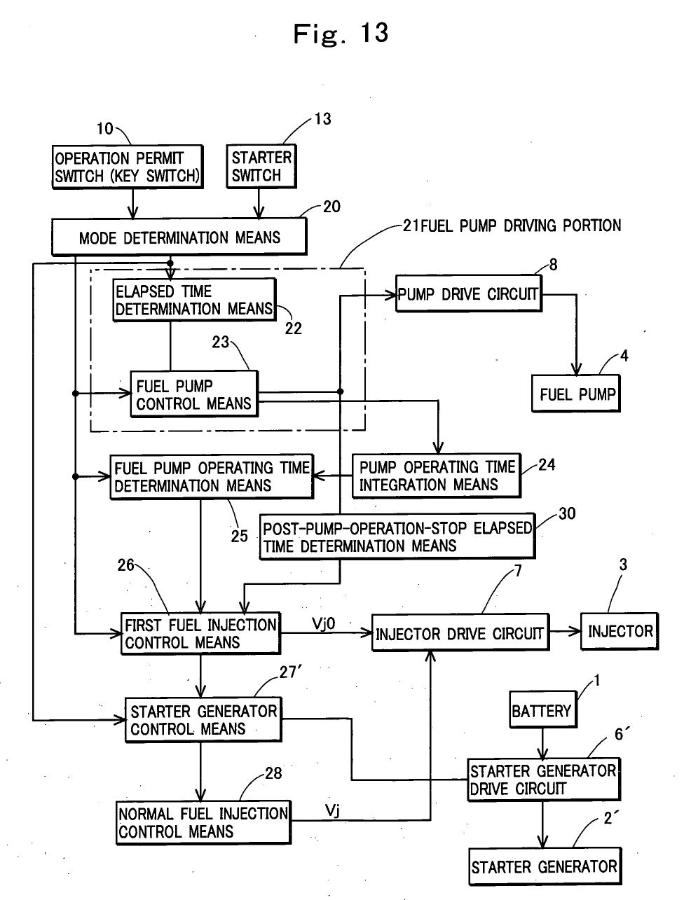

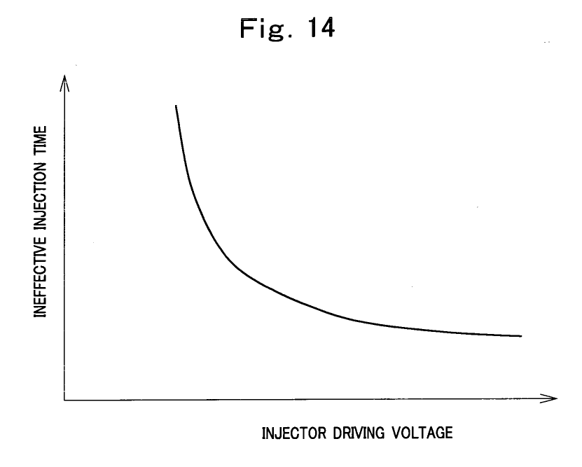

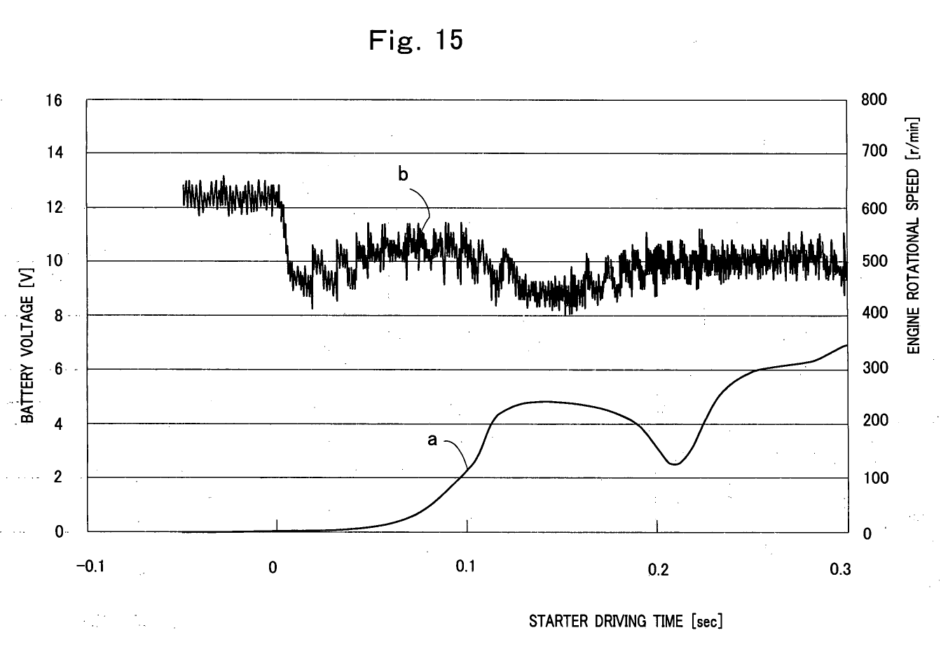

Next, a further embodiment of the present invention will be described with reference to FIGS. 11 to 13. FIG. 11 is a block diagram showing a construction of hardware of the embodiment, FIG. 12 is a schematic circuit diagram showing an exemplary configuration of a starter generator driving portion in FIG. 11, and FIG. 13 is a block diagram showing a construction of a control device including portions comprised by a microprocessor.

In FIG. 11, the same components as in FIG. 1 are denoted by the same reference numerals. In the embodiment, as a rotating electric machine, a starter generator 2′ is mounted to an engine instead of the starter motor in FIG. 1. The starter generator 2′ is a rotating electric machine that is operated as a starter motor at the start of the engine, and as a generator for charging a battery after the completion of the start of the engine. The rotating electric machine is comprised of, for example, a magnet rotor comprised by mounting a permanent magnet to a rotor yoke, and a stator having an armature coil wound around an armature core having magnetic pole portions facing magnetic poles of the magnet rotor, driven as a brushless motor at the start of the engine, and driven by the engine to operate as a magnetic AC generator after the start of the engine.

FIG. 12 shows an exemplary construction of a starter generator driving circuit 6′ when a starter generator is used that is comprised of a magnet rotor having 2n poles (n is an integer equal to or more than 1) and a stator having 3n poles, operates as a three-phase brushless motor at the start of the engine, and operates as a three-phase magnetic AC generator after the start of the engine.

The starter generator driving circuit 6′ in FIG. 12 is comprised of a three-phase inverter circuit, which comprises a three-phase bridge switch circuit in which switches Qu to Qw having one ends commonly connected form an upper side of a bridge, and switches Qx to Qz having one ends connected to the other ends of the switches Qu to Qw and the other ends commonly connected form a lower side of the bridge, and a three-phase full-wave rectifier circuit comprised of diodes Du to Dw connected in anti-parallel to the switches Qu to Qw and diodes Dx to Dz connected in anti-parallel to the switches Qx to Qz. The switches Qu to Qw and Qx to Qz may be switch elements that can be freely turned on/off. In the example in FIG. 12, the switches are comprised of MOSFETs.

Lu to Lw denote a three-phase armature coil star connected of the starter generator 2′, and terminals of the armature coil opposite to a neutral point are connected to three-phase AC terminals 6u to 6w of the inverter circuit. The battery 1 is connected between DC terminals 6a and 6b of the inverter circuit.

When the starter generator driving portion is used, a position sensor that detects a rotational angle position of the magnet rotor is provided, and rotational angle position information of the rotor detected by the position sensor is provided to the microprocessor. Then, at the start of the engine, with consideration for prevention of a short-circuit across the battery 1, drive signals are provided to one switch selected from the switches Qu to Qw on the upper side of the bridge of the inverter circuit and one switch selected from the switches Qx to Qz on the lower side of the bridge, and the switches having received the drive signals are turned on to pass a driving current from the battery 1 through the armature coil Lu to Lw so as to pass the driving current through the armature coil Lu to Lw in an energization pattern required for rotating the magnet rotor in the direction of starting the engine.

After the start of the engine, a three-phase AC voltage induced in the armature coil Lu to Lw is rectified through the three-phase full-wave rectifier circuit comprised of the diodes Du to Dw and Dx to Dz and supplied to the battery 1. The induced voltage in the armature coil increases with increasing rotational speed of the engine, and thus the microprocessor controls the inverter circuit so as to maintain a voltage applied across the battery within a set range and controls a generation output.

The generation output can be controlled by on/off control of the switches that comprise the inverter circuit so as to short-circuit the generation output when the voltage across the battery exceeds the set value, and remove the short circuit when the voltage across the battery becomes lower than the set value. Specifically, the microprocessor simultaneously provides drive signals to the switches Qx to Qz on the lower side of the bridge of the inverter circuit when the battery voltage detected by a battery voltage detecting portion 12 exceeds the set value, or simultaneously provides drive signals to the switches Qu to Qw on the upper side of the bridge, to simultaneously turn on the switches Qx to Qz on the lower side of the bridge or the switches Qu to Qw on the upper side of the bridge, and short-circuit a three-phase output of the starter generator, thereby reducing the generation output of the starter generator. When the voltage applied to the battery becomes lower than the set value, the provision of the drive signals to the switches Qx to Qz or the switches Qu to Qw is stopped to remove the short circuit of the three-phase output of the starter generator, and restore the generation output. These operations maintain the voltage applied to the battery 1 within a set range.

In the embodiment, two microprocessors: the first microprocessor 5A and the second microprocessor 5B are provided, the first microprocessor 5A controls the fuel pump 4 and the injector 3, and the second microprocessor 5B controls the starter generator 2′.

The first microprocessor 5A and the second microprocessor 5B receive a power voltage from the battery 1 through a key switch 10 and a voltage regulating portion 11. An output of the battery voltage detecting portion 12 is provided to both the first microprocessor and the second microprocessor, and an output of the crank angle sensor 15 is provided to both the first microprocessor and the second microprocessor. The first microprocessor 5A and the second microprocessor 5B are connected by a communication line for data exchange, and data stored in one of the first microprocessor and the second microprocessor can be read in the other, or a signal generated by one of the first microprocessor and the second microprocessor can be received by the other. For example, data on a rotational speed of the engine arithmetically operated by the first microprocessor 5A can be read in the second microprocessor 5B.

A construction of the control device including means comprised of the microprocessors in this embodiment is as shown in FIG. 13. The construction of the control device in FIG. 13 is the same as the construction of the control device in FIG. 2 except that the starter generator 2′ is used instead of the starter motor 2 in FIG. 2, the starter generator driving circuit 6′ in FIG. 11 is provided instead of the starter driving circuit 6, and starter generator control means 27′ is provided instead of the starter control means in FIG. 2, which activates the starter generator 2′ as a starter motor when the first fuel injection is completed, stops the operation of the starter generator 2′ as the starter motor when the start of the engine is completed, and controls a generation output of the starter generator so that the voltage across the battery 1 does not exceed the set value after the start of the engine is confirmed.

Algorithms of processings executed by the first microprocessor 5A for constructing fuel pump driving portion 21, pump operating time integration means 24, fuel pump operating time determination means 25, and first fuel injection control means 26 of the control device in FIG. 13 are the same as in FIGS. 3 and 4.

The second microprocessor 5B executes a starter motor control routine for a processing for driving the starter generator as the starter motor when receiving a command to permit driving of the starter motor from the first microprocessor, a generation output control routine for a processing for controlling the generation output of the starter generator that operates as the generator after the start of the engine is completed and the driving of the starter motor is stopped, and an ignition operation control routine for a processing for controlling an ignition device that ignites the engine during rotation of the crankshaft. The starter generator control means 27′ is comprised of the starter motor control routine and the generation output control routine. A method of controlling the inverter circuit for driving the brushless motor, a method of controlling the inverter circuit for controlling the generation output, and a method for controlling the ignition device have been known, and thus detailed descriptions on the above described control routines will be omitted.

As described above, according to the present invention, the operation of the fuel pump is started after the operation permit command to permit the operation of the engine is given and before the start command to start the engine is given, and the injector is caused to perform the first fuel injection at the start of the engine when both the conditions are met that the start command is given and that the fuel pump is continuously operated for the set time or longer. This allows a sufficient amount of fuel to be injected in the first fuel injection, and prevents a shortage of the fuel at the start of the engine. In the present invention, the starter motor is driven to start the engine immediately after the first fuel injection, thereby preventing an air/fuel mixture from going lean, and improving startability of the engine.

Thus, according to the present invention, the startability of the engine can be improved, thereby preventing exhaust of unburned gas at the start of the engine to improve an exhaust gas characteristic at the start.

Although the preferred embodiments of the invention have been described and illustrated with reference to the accompanying drawings, it will be understood by those skilled in the art that these are by way of examples, and that various changes and modifications may be made without departing from the spirit and scope of the invention, which is defined only to the appended claims.

What is claimed is:

1. An engine control device that controls a fuel injection device including an injector that injects fuel to be supplied to an engine and a fuel pump that supplies the fuel to said injector, and a rotating electric machine that operates as a motor that rotatably drives a crankshaft of said engine at the start of said engine, using a microprocessor, comprising:
a fuel pump driving portion that starts operating said fuel pump between when an operation permit command to permit the operation of said engine is given and when a start command to start said engine is given, and continuously operates said fuel pump after said start command is given;
first fuel injection control means for causing said injector to perform first fuel injection at the start of the engine when both conditions are met that said start command is given and that said fuel pump is continuously operated for a set time or longer, or when said start command is given within a set limited time after the continuous operation of said fuel pump for a time longer than said set time is stopped;
rotating electric machine control means for controlling said rotating electric machine so as to start driving said rotating electric machine as the motor when said first fuel injection is completed, and stop driving said rotating electric machine as the motor when the start of said engine is completed; and
normal state fuel injection control means for causing said injector to perform fuel injection at a predetermined crank angle position of said engine.

2. The engine control device according to claim 1, wherein said fuel pump driving portion is comprised so as to operate said fuel pump for a certain time when the operation permit command to permit the operation of said engine is given, and continuously operate said fuel pump after the start command to start said engine is given.

3. The engine control device according to claim 1, wherein said fuel pump driving portion is comprised so as to start the continuous operation of said fuel pump when the start command to start said engine is given after the operation permit command to permit the operation of said engine is given, and
said first fuel injection control means is configured to cause the injector to perform the first fuel injection at the start of the engine when said start command is given and the operating time of said fuel pump reaches the set time.

4. The engine control device according to claim 1, wherein said rotating electric machine is provided so as to operate as a motor that starts said engine at the start of said engine, and be driven by said engine after the start of said engine and operate as a battery charging generator, and
said rotating electric machine control means is comprised so as to start driving said rotating electric machine as the motor when said first fuel injection is completed, stop the driving of said rotating electric machine as the motor when the start of said engine is completed, and control a generation output of said rotating electric machine that operates as the generator for maintaining a voltage across a battery within a set range after the start of said engine is confirmed.

5. The engine control device according to claim 4, wherein two microprocessors are provided, and said fuel pump driving portion, said first fuel injection control means, and said normal state fuel injection control means are comprised of one of said two microprocessors, and
said rotating electric machine control means is comprised of the other of said two microprocessors.

6. The engine control device according to claim 1, wherein said rotating electric machine is provided so as to operate as a motor that starts said engine at the start of said engine, and be driven by said engine after the start of said engine and operate as a battery charging generator,
said fuel pump driving portion is comprised so as to operate said fuel pump for a certain time when the operation permit command to permit the operation of said engine is given, and continuously operate said fuel pump after the start command to start said engine is given,
said first fuel injection control means is comprised so as to cause said injector to perform first fuel injection at the start of the engine when both conditions are met that said start command is given and that said fuel pump is continuously operated for a set time or longer, and
said rotating electric machine control means is comprised so as to start driving said rotating electric machine as the motor when said first fuel injection is completed, stop the driving of said rotating electric machine as the motor when the start of said engine is completed, and control a generation output of said rotating electric machine that operates as the generator for maintaining a voltage across a battery within a set range after the start of said engine is confirmed.

7. The engine control device according to claim 6, wherein two microprocessors are provided, and said fuel pump driving portion, said first fuel injection control means, and said normal state fuel injection control means are comprised of one of said two microprocessors, and
said rotating electric machine control means is comprised of the other of said two microprocessors.

8. The engine control device according to claim 1, wherein said rotating electric machine is provided so as to operate as a motor that starts said engine at the start of said engine, and be driven by said engine after the start of said engine and operate as a battery charging generator,
said fuel pump driving portion is comprised so as to start the continuous operation of said fuel pump when the start command to start said engine is given after the operation permit command to permit the operation of said engine is given,
said first fuel injection control means is comprised so as to cause the injector to perform the first fuel injection at the start of the engine when said start command is given and the operating time of said fuel pump reaches the set time, and
said rotating electric machine control means is comprised so as to start driving said rotating electric machine as the motor when said first fuel injection is completed, stop the driving of said rotating electric machine as the motor when the start of said engine is completed, and control a generation output of said rotating electric machine that operates as the generator for maintaining a voltage across a battery within a set range after the start of said engine is confirmed.

9. The engine control device according to claim 8, wherein two microprocessors are provided, and said fuel pump driving portion, said first fuel injection control means, and said normal state fuel injection control means are comprised of one of said two microprocessors, and
said rotating electric machine control means is comprised of the other of said two microprocessors.
